(19) United States
(12) Patent Application Publication
(10) Pub. No.: US 2007/0145165 A1
(43) Pub. Date: Jun. 28, 2007

(54) Electromagnetic fuel injection valve

(76) Inventors: Tsutomu Murakami, Kanagawa-ken (JP); Kousuke Ohnishi, Kanagawa-ken (JP); Gensaku Konagai, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/337,003

(22) Filed: Jan. 23, 2006

(30) Foreign Application Priority Data
Dec. 19, 2005 (JP) 2005-364329

(51) Int. Cl. F02M 51/00; B05B 1/30

(52) U.S. Cl. 239/585.3; 239/585.1; 239/585.4; 239/900

(57) ABSTRACT

The invention provides an electromagnetic fuel injection valve which is operated extremely normally, is excellent in a durability, can always obtain a stable injection amount, and can reduce an influence by a fuel, an atmospheric temperature and the like. In an electromagnetic fuel injection valve (1) in which an electromagnetic valve (2) corresponding to a drive source is constituted by a yoke (21), a core (22) and a movable valve (23), an injection nozzle (41) interiorly provided with a ball valve (43) and having an injection port (42) for injecting a fuel is arranged in a leading end of the movable valve (23) so as to form an injection valve (4), and a return spring (3) bonded to the movable valve (23) and an adjusting screw (5) pressure supporting the return spring (3) are arranged in an axial hole (25) of the core (22) by being fitted and inserted to the axial hole (25) of the core (22) from an opening in a base end side, a connection lever (6) is slidably interposed between the adjusting screw (5) in the axial hole (25) of the core (22) and the return spring (3).

### BACKGROUND OF THE INVENTION

1. Field of the Invention

The present invention relates to a fuel injection valve supplying a fuel to an engine which can obtain an output by burning a gasoline or the other fuels, and more particularly to an electromagnetic fuel injection valve structured such as to adjust a fuel injection amount of the engine by an electromagnetic valve and a return spring.

2. Description of the Related Art

FIG. 8 is a vertical cross sectional view of a conventional electromagnetic fuel injection valve 1, for example, disclosed in Japanese Unexamined Patent Publication No. 55-40391, Japanese Unexamined Patent Publication No. 6-336961, Japanese Unexamined Patent Publication No. 7-151034 and the like. The electromagnetic fuel injection valve 1 is structured such that an electromagnetic valve 2 corresponding to a drive source is constituted by a yoke 21, a core 22 and a movable valve 23, and an injection valve 4 formed by a ball valve 43 pressed to an injection port 42 of an injection nozzle 41 by a return spring 3 arranged in a base end of the movable valve 23 is arranged in a leading end of the movable valve 23.

Further, the electromagnetic fuel injection valve 1 is structured such that the movable valve 23 is sucked against a pressing force (a valve closing force) of the return spring 3 on the basis of a magnetic force generated in a coil 24 wound around the core 22, whereby the injection valve 4 is opened, and the fuel pressure fed and supplied into the injection valve 4 by a fuel pump (not shown) is injected to a combustion chamber (not shown) of the engine from the injection port 42 of the opened injection nozzle 41 (refer to FIG. 9).

In this case, an injection amount of the fuel in the electromagnetic fuel injection valve 1 depends on a time for which the injection valve 4 is opened (hereinafter, refer to “injection pulse width”) as shown in FIG. 10, and in particular, a change amount of the fuel injection amount with respect to the injection pulse width is controlled by an affecter of a pressing force (load amount) of the return spring 3 and the injection pulse width as shown in FIG. 10.

Accordingly, as shown in FIG. 8, the pressing force (the load amount) of the return spring 3 can be optionally set by screwing and inserting an adjusting screw 5 bonded to the base end side of the movable valve 23 via the return spring 3 into an axial hole 25 of the core 22 from the base end side.

However, in the case that the adjusting screw 5 employs a screw having a normally mass-produced quality, it is necessary to form a suitable gap between the adjusting screw 5 and the axial hole 25 for securing a mounting property to the axial hole 25. As a result, as shown in FIG. 11, the adjusting screw 5 pushes the return spring 3 in an oblique direction, the adjusting screw 5 and the return spring 3 are brought into contact with a wall surface of the axial hole 25 more than necessary, and the return spring 3 is in an eccentric state. Accordingly, not only a performance under a concentric state can not be achieved, but also a reproducibility is deteriorated. In particular, in the conventional structure, a shaft portion 51 of the adjusting screw 5 is long and tends to be inclined.

Further, since the return spring 3 is brought into contact with the wall surface of the axial hole 25 while forming a curved shape, the return spring 3 tends to wear, a durability is lowered, and a broken piece forms a foreign material so as to exert a bad influence.

Accordingly, as a countermeasure for preventing the incline of the adjusting screw 5, there can be considered a matter that the gasp with the axial hole 25 is made small, however, a galling is generated between both the elements. Further, even if the gap is made small, it is necessary to improve a material and a working precision of each of the parts for normally functioning. Accordingly, this structure can not be employed in view of the productivity. Particularly, the smaller the structure is, the more the influence is exerted.

On the other hand, there has been employed a means for pressure inserting the adjusting means without using any screw, in place of the adjusting screw 5 (not shown), however, the foreign matter such as a chip tends to be generated at a time of production, and there is a risk that a motion of the movable valve 23 is affected, and a fuel leak is generated due to an engagement of a seat portion.

### SUMMARY OF THE INVENTION

The present invention is made by taking the conditions mentioned above into consideration, and an object of the present invention is to provide an inexpensive electromagnetic fuel injection valve which is operated extremely normally without an adjusting screw and a return spring being inclined even if the adjusting screw and a core made of a normal material are used, is excellent in a durability, can always obtain a stable injection amount, and can reduce an influence by a fuel, an atmospheric temperature and the like.

In order to achieve the object mentioned above, in accordance with the present invention, there is provided an electromagnetic fuel injection valve in which an electromagnetic valve corresponding to a drive source is constituted by a yoke, a core and a movable valve, an injection nozzle interiorly provided with a ball valve and having an injection port for injecting a fuel is arranged in a leading end of the movable valve so as to form an injection valve, and a return spring bonded to the movable valve and an adjusting screw pressure supporting the return spring are arranged in an axial hole of the core by being fitted and inserted to the axial hole of the core from an opening in a base end side, wherein a connection lever is slidably interposed between the adjusting screw in the axial hole of the core and the return spring.

In accordance with the present invention, since the connection lever is slidably interposed between the adjusting screw in the axial hole of the core and the return spring, a shaft portion of the adjusting screw becomes short and is hard to be inclined. Further, even if the connection lever is inclined due to some reasons, the connection lever is only in contact with the adjusting screw and is not constrained, so that the connection lever is not affected by the incline of the adjusting screw. In addition, since it is possible to reduce the gap between the connection lever and the axial hole of the core, it is possible to press the return spring in a stable state, and the return spring is normally operated without being inclined, it is possible to stably inject the fuel.

Further, in the present invention, in the case that the leading end of the shaft portion of the adjusting screw is formed in a semispherical shape, a contact area between the adjusting screw and the connection lever is reduced. Accordingly, a freedom about the joint between the adjusting screw and the connection lever is increased, a constraint relation between both the elements is reduced, and the influence by the incline of the adjusting screw can be reduced.

Further, in the present invention, in the case that the connection lever and the yoke are respectively formed by materials having different linear expansion coefficients from each other, it is possible to solve an increase of fuel temperature and a change of a coil resistance generated by an increase of the atmospheric temperature or the like, by adjusting a load of the return spring.

As mentioned above, in accordance with the present invention, it is possible to provide an inexpensive electromagnetic fuel injection valve which uses the adjusting screw and the core made of the normal material similar to the conventional electromagnetic fuel injection valve, can always inject the fuel in a stable state without increasing a working precision and particularly complicating an assembling step, and is excellent in a durability. Further, it is possible to achieve a fixed amount of fuel injection even under a high-temperature atmosphere.

### BRIEF DESCRIPTION OF THE DRAWINGS

FIG. 1 is a vertical cross sectional view showing an embodiment in accordance with the present invention;

FIG. 2 is a schematic view showing an operation of the embodiment shown in FIG. 1;

FIG. 3 is a view showing a relation between a load and a fuel injection amount;

FIG. 4 is a view showing a relation between a fuel temperature and a fuel injection amount;

FIG. 5 is a view showing a relation between a coil temperature and a fuel injection amount change rate;

FIG. 6 is a vertical cross sectional view shoring the other embodiment in accordance with the present invention;

FIG. 7 is a schematic view showing an operation of the embodiment shown in FIG. 6;

FIG. 8 is a vertical cross sectional view showing a prior art;

FIG. 9 is a view shoring a relation between an opening and closing of an injection, valve and a welding time in the prior art;

FIG. 10 is a view showing a relation between a fuel injection amount and an injection pulse width; and

FIG. 11 is a schematic view showing an operation of the prior art shown in FIG. 8.

### DESCRIPTION OF THE PREFERRED EMBODIMENTS

Next, a description will be given in detail of preferred embodiments in accordance with the present invention with reference to the accompanying drawings.

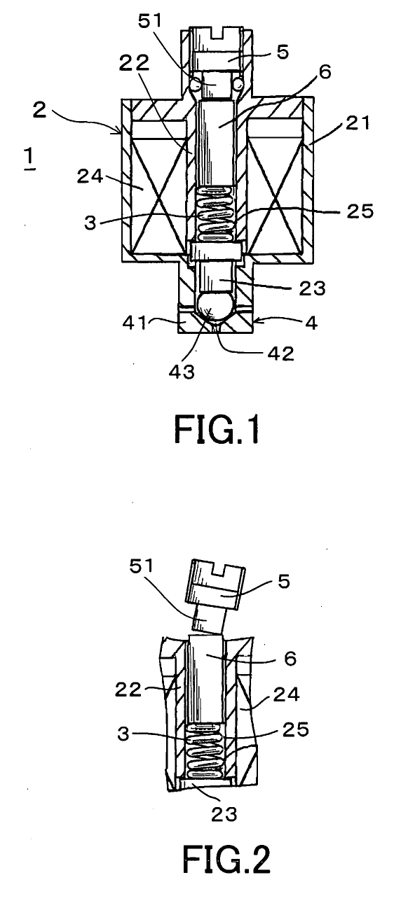

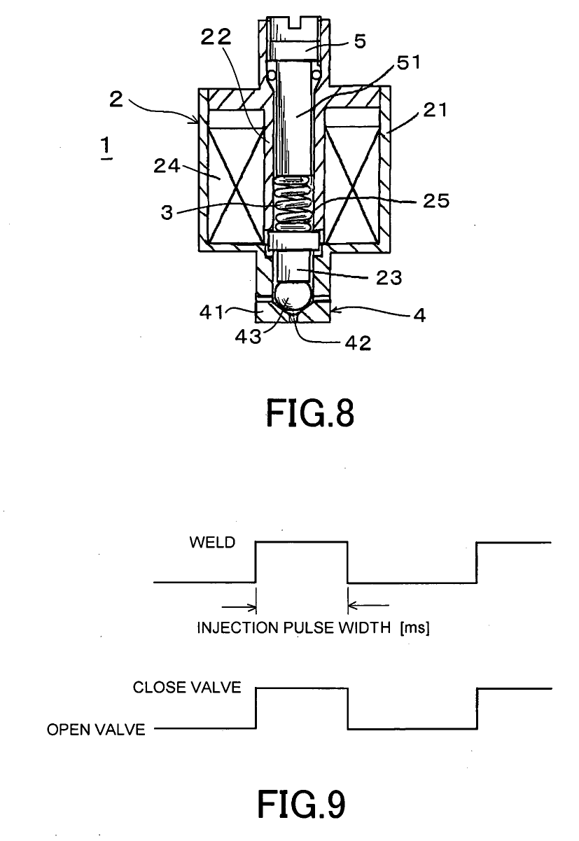

FIG. 1 shows a preferable embodiment in accordance with the present invention. An electromagnetic fuel injection valve 1 in accordance with the present invention is the same as the conventional one shown in FIG. 8 in a basic structure, and is structured such that an electromagnetic valve 2 corresponding to a drive source is constituted by a yoke 21, a core 22 and a movable valve 23, and an injection valve 4 formed by a ball valve 43 pressed to an injection port 42 of an injection nozzle 41 by a return spring 3 arranged in a base end of the movable valve 23 is arranged in a leading end of the movable valve 23, the movable valve 23 is sucked against a pressing force (a valve closing force) of the return spring 3 on the basis of a magnetic force generated in a coil 24 wound around the core 22, whereby the injection valve 4 is opened, and the fuel pressure fed and supplied into the injection valve 4 by a fuel pump (not shown) is injected to a combustion chamber (not shown) of the engine from the injection port 42 of the opened injection nozzle 41.

The present embodiment is different in a point that a connection lever 6, for example, formed in a cylindrical shape and having a predetermined length is slidably interposed between the adjusting screw 5 in the axial hole 25 of the core 22 and the return spring 3.

In the present embodiment, since a shaft portion 51 of the adjusting screw 5 becomes short by slidably interposing the connection lever 6 between the adjusting screw 5 and the return spring 3, the adjusting screw 5 is hard to be inclined even by processing the gap between the adjusting screw 5 and the axial hole 25 of the core 22 in the same level as the electromagnetic fuel injection valve.

Further, since the connection lever 6 is only in contact with the adjusting screw 5 on the basis of the pressing force of the return spring 3 and is not constrained, the connection lever 6 is not affected by the incline even if the adjusting screw 5 is inclined as shown in FIG. 2, and the connection lever 6 only slides along an axis within the axial hole 25 of the core 22. Accordingly, since it is possible to reduce the gap between the connection lever 6 and the axial hole 25, the connection lever 6 can press the return spring 3 in a stable state without being inclined as is different from the adjusting screw 5. Therefore, since the return spring 3 is normally operated without being inclined, it is possible to stably inject the fuel.

Particularly, in accordance with the present embodiment, the assembly is achieved only by inserting the connection lever 6 before screwing the adjusting screw 5 to the axial hole 25 of the core 22, and there is no risk that a productivity and a cost are affected.

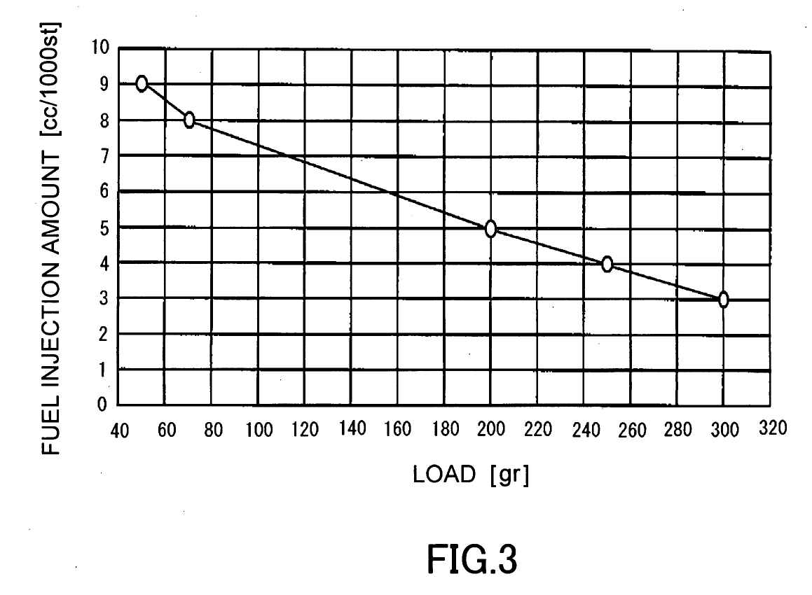

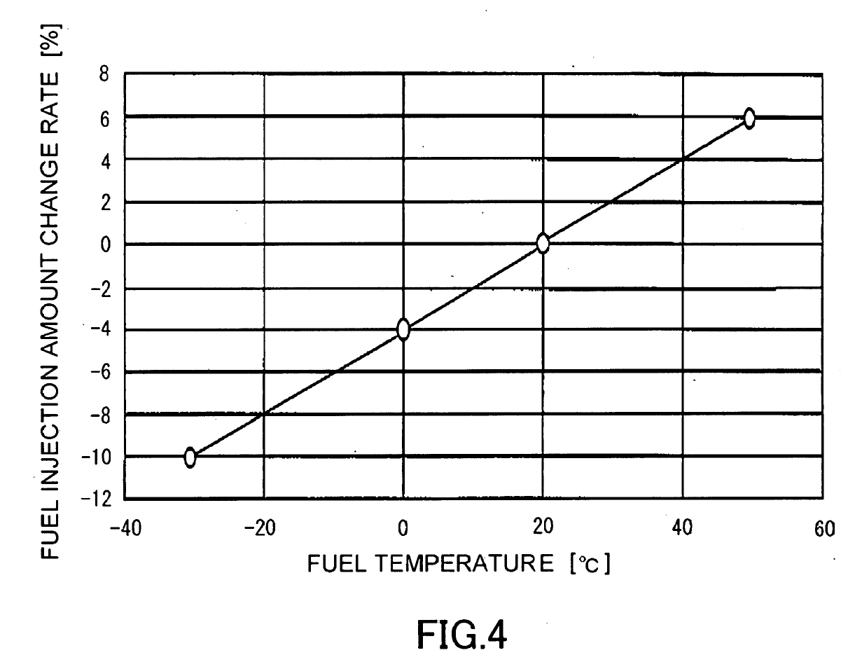

Further, in the electromagnetic fuel injection valve shown in the present embodiment, in the same injection pulse width, the fuel injection amount is reduced in accordance with an increase of the pressing force (the load) of the return spring 3, as shown in FIG. 3, and a viscosity is lowered and the injection amount is increased in accordance with an ascent of the fuel temperature, as shown in FIG. 4.

Accordingly, in the present embodiment, if the yoke 21 is formed by a stainless steel (SUS) material, and the connection lever 6 is formed by a brass material having a larger linear expansion coefficient than that of the stainless steel (SUS) material, when the temperature is increased due to the heat of the engine and the atmosphere, the connection lever 6 formed by the brass material is more largely elongated than the yoke 21 formed by the stainless steel (SUS) material. Accordingly, since the distance between the connection lever 6 and the movable valve 23 is narrowed in accordance with the increase of the temperature, and the pressing force (the load) of the return spring 3 interposed between both the elements is increased, it is possible to suppress the influence by the temperature increase to the minimum coping with the increase of the injection amount caused by the viscosity reduction due to the increase of the fuel temperature mentioned above.

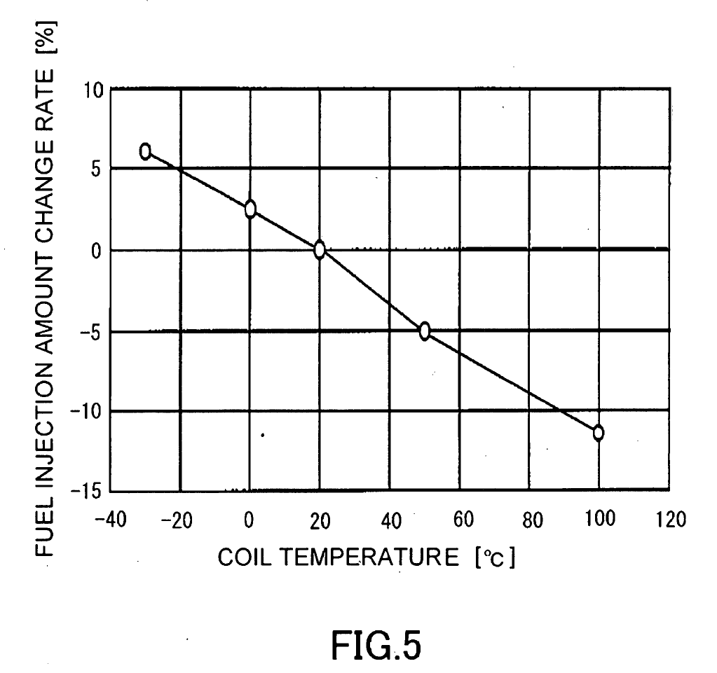

On the other hand, in the injection apparatus using the electromagnetic valve as in the present embodiment, since the resistance value of the coil 24 constituting the electromagnetic valve is generally increased in accordance with the weld state and the atmospheric temperature, the current circulating through the coil is reduced. Accordingly, the fuel injection amount is reduced on the basis of the increase of the coil temperature, as shown in FIG. 5.

In the present embodiment, if the yoke 21 is formed by the stainless steel (SUS) material, and the connection lever 6 is formed by a ceramic material or the like having a smaller linear expansion coefficient than that of the stainless steel (SUS) material, the elongation of the connection lever 6 formed by the brass material is smaller than the yoke 21 formed by the stainless steel (SUS) material, in the case that the resistance value of the coil 24 is increased on the basis of the heat of the engine and the atmosphere. Accordingly, the distance between the connection lever 6 and the movable valve 23 is enlarged in accordance with the increase of the temperature, and the pressing force (the load) of the return spring 3 interposed between both the elements is lowered. Therefore, it is possible to cope with the reduction of the injection amount caused by the increase of the resistance value of the coil due to the increase of the fuel temperature mentioned above (refer to FIG. 3).

As mentioned above, the present embodiment can inexpensively cope with the change of the injection amount caused by the temperature without changing the structure itself and adding any electric means, by forming the yoke 21 and the connection lever 6 by the materials having the different linear expansion coefficients from each other.

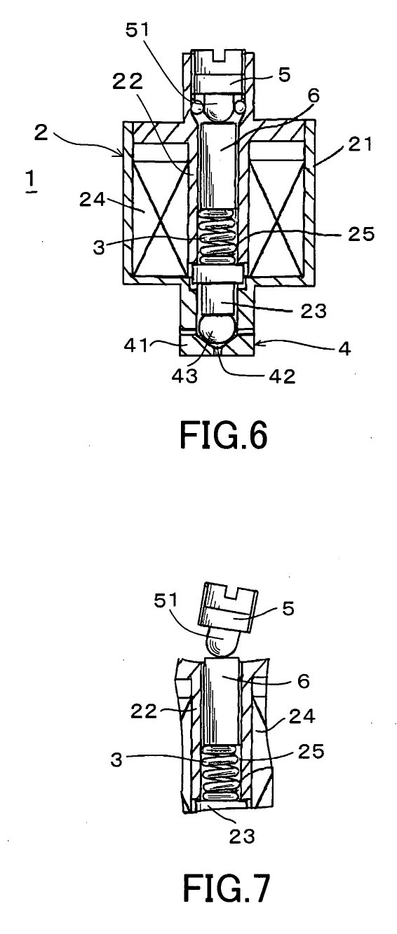

Further, FIG. 6 shows a different embodiment in accordance with the present invention. An entire structure thereof is approximately the same as the embodiment shown in FIG. 1, however, this embodiment is different in a point that a leading end of a shaft portion 51 of the adjusting screw 5 is formed as a semispherical shape.

In the present embodiment, since a contact area between the adjusting screw 5 and the connection lever 6 is further reduced, a freedom about the joint between the adjusting screw 5 and the connection lever 6 is increased, and the constraint between both the elements is reduced as shown in FIG. 7. Accordingly, it is possible to reduce the influence by the incline of the adjusting screw 5.

FIG. 3

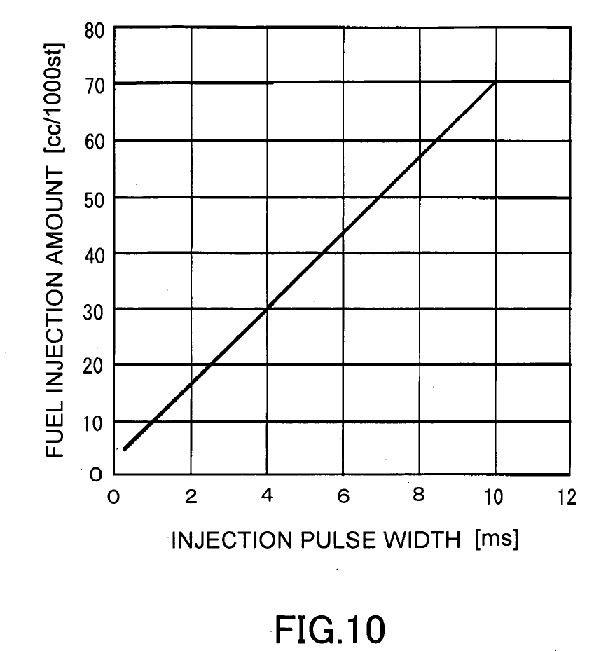

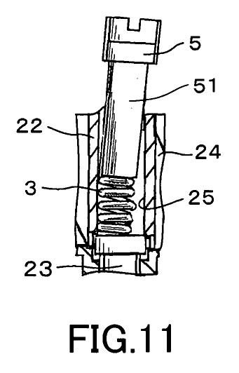

FUEL INJECTION AMOUNT
LOAD
   FIG. 4
FUEL INJECTION AMOUNT CHANGE RATE
FUEL TEMPERATURE
   FIG. 5
FUEL INJECTION AMOUNT CHANGE RATE
COIL TEMPERATURE
   FIG. 9
WELD
INJECTION PULSE WIDTH
CLOSE VALVE
OPEN VALVE
   FIG. 10
FUEL INJECTION AMOUNT
INJECTION PULSE WIDTH

What is claimed is:

1. An electromagnetic fuel injection valve in which an electromagnetic valve corresponding to a drive source is constituted by a yoke, a core and a movable valve, an injection nozzle interiorly provided with a ball valve and having an injection port for injecting a fuel is arranged in a leading end of said movable valve so as to form an injection valve, and a return spring bonded to said movable valve and an adjusting screw pressure supporting said return spring are arranged in an axial hole of said core by being fitted and inserted to the axial hole of said core from an opening in a base end side, wherein a connection lever is slidably interposed between the adjusting screw in the axial hole of said core and the return spring.

2. An electromagnetic fuel injection valve as claimed in claim 1, wherein a leading end of the shaft portion of said adjusting screw is formed in a semispherical shape.

3. An electromagnetic fuel injection valve as claimed in claim 1 or 2, wherein said connection lever and the yoke are respectively formed by materials having different linear expansion coefficients from each other.
